(19) United States
(12) Patent Application Publication
(10) Pub. No.: US 2025/0170881 A1
(43) Pub. Date: May 29, 2025

(54) STRUCTURE FOR PREVENTING EXPOSURE OF A JOINT PART OF A VEHICLE BODY

(71) Applicants: HYUNDAI MOTOR COMPANY, Seoul (KR); KIA CORPORATION, Seoul (KR)

(72) Inventors: Jiseo Park, Hwaseong-si (KR); Tae Han Kang, Hwaseong-si (KR)

(73) Assignees: HYUNDAI MOTOR COMPANY, Seoul (KR); KIA CORPORATION, Seoul (KR)

(21) Appl. No.: 18/932,211

(22) Filed: Oct. 30, 2024

(30) Foreign Application Priority Data
Nov. 24, 2023 (KR) 10-2023-0166073

(51) Int. Cl. B60J 11/02; B62D 63/02

(52) U.S. Cl. CPC B60J 11/025; B62D 63/025

(57) ABSTRACT

A structure for preventing exposure of a joint part of a vehicle body is provided, and includes: a first fixing member disposed inside the coupling part and extending in a horizontal direction of the drive module; a second fixing member extending in the horizontal direction and spaced apart from the first fixing member; a connection member configured to connect and support the first fixing member and the second fixing member and configured to be changed in shape by a movement of the second fixing member; a blocking member having one portion connected to the second fixing member and configured to prevent the joint part of the vehicle body from being exposed to the outside; a rotary member extending in the horizontal direction in parallel with the first fixing member; and a motor assembly configured to provide driving power to move the second fixing member.

### CROSS-REFERENCE TO RELATED APPLICATION

This application claims priority to and the benefit of Korean Patent Application No. 10-2023-0166073 filed in the Korean Intellectual Property Office on Nov. 24, 2023, the entire contents of which are incorporated herein by reference.

### BACKGROUND

### (a) Field of the Disclosure

The present disclosure relates to a structure for preventing exposure of a joint part of a vehicle body, and more particularly, to a structure for preventing exposure of a joint part when a drive module and a space module are fastened together in a purpose-built vehicle (PBV).

### (b) Description of the Related Art

Recently, future mobility visions with new concepts for implementing human-oriented dynamic future cities have been introduced in vehicle industries. One of the future mobility solutions is a purpose-built vehicle (PBV) as a purpose-based mobility vehicle.

Examples of the PBV may include an environmentally-friendly movable vehicle based on an electric vehicle (EV). The PBVs may provide various customized services to users while the PBVs move from starting points to destinations in an unmanned or manned autonomous driving manner.

The PBV may include a cab-type drive module equipped with a drive device and capable of autonomously traveling. The PBV may also include a space module coupled to the drive module and configured to be used for cargo, passengers, home office, or the like.

The drive module and the space module may be fastened to each other by a coupling device such as a fastening pin and a fastening slot. Only the drive module may travel when the drive module and the space module are separated. However, when only the drive module travels or the space module is not used (parking situation), a fastened part between the modules is exposed to the outside, which impairs an aesthetic appearance. In addition, the exposure of the coupling device increases the probability of problems of contamination, breakdowns, and the like.

In the related art, a door-type device is adopted to prevent the exposure of components in the vehicle. However, there is a problem in that a structure of a sliding or collapsible door device is complicated, and a large space in the vehicle is occupied by the sliding or collapsible door device. In addition, the weight of the door-type device increases the overall weight of the vehicle, which causes problems such as deteriorating fuel economy of the vehicle and increased installation costs.

### SUMMARY

The present disclosure provides a structure for preventing exposure of a joint part of a vehicle body, in which a compact roller-type blocking structure is applied to prevent exposure of a joint part when a drive module and a space module are not fastened together in a PBV, which may improve an aesthetic appearance and prevent external contamination.

An embodiment of the present disclosure provides a structure for preventing exposure of a joint part of a vehicle body for a vehicle including a drive module and a space module configured to be coupled to a rear end of the drive module, the structure being configured to be applied to a coupling part, which is provided at the rear end of the drive module, and including: a first fixing member disposed inside the coupling part and extending in a horizontal direction of the drive module; a second fixing member extending in the horizontal direction and spaced apart from the first fixing member, the second fixing member being configured to move in a vertical direction so that a relative distance from the first fixing member is changeable; a connection member configured to connect and support the first fixing member and the second fixing member and configured to be changed in shape by a movement of the second fixing member; a blocking member having one portion connected to the second fixing member, the blocking member being configured to cover a relative distance or space, which is defined by a distance or space between the first fixing member and the second fixing member, by the movement of the second fixing member in order to prevent the joint part of the vehicle body from being exposed to the outside; a rotary member extending in the horizontal direction in parallel with the first fixing member and connected to another portion of the blocking member, the rotary member being configured to rotate when the blocking member moves to roll the blocking member; and a motor assembly configured to provide driving power to move the second fixing member.

Two opposite ends of the first fixing member may be fixed by a mounting bracket provided inside the coupling part.

Two opposite ends of the rotary member may be rotatably coupled to the mounting bracket by bearings.

Spiral springs may be provided inside the two opposite ends of the rotary member, and the other portion of the blocking member may be connected to the spiral spring.

The connection member may be provided as a pair of connection members disposed in parallel between the first fixing member and the second fixing member.

The connection member may be configured as two-stage collapsible arms connected by a rivet and configured to be unfolded or folded in accordance with the relative distance between the first fixing member and the second fixing member.

The other portion of the blocking member may be connected to the spiral springs such that tension is maintained by the spiral springs, and the blocking member may move in accordance with a relative movement between the first fixing member and the second fixing member and rolls along an outer peripheral surface of the rotary member.

The blocking member may be configured as an awning made of tarpaulin or soltop (i.e., SOL Tarpaulin).

The motor assembly may include: a motor; a connection rod connected to two opposite sides of a rotary shaft of the motor and extending in the horizontal direction; and driving gears provided at two opposite ends of the connection rod.

The motor assembly may be fixed to a motor fixing bracket fixed to the second fixing member and configured to move together with the movement of the second fixing member.

A fastening bracket may be formed on an outer surface of the motor, and the motor may be coupled to the motor fixing bracket through the fastening bracket by bolting.

The driving gears may be coupled to guide tracks formed at two opposite inner ends of the coupling part and extending in the vertical direction, and the driving gears may move along the guide tracks.

The driving gear may be configured as a pinion gear, and the guide track may be configured as a rack gear.

The structure may further include an electric wire reel provided at an inner central portion of the mounting bracket, connected to the motor by wiring, and configured to apply electric power.

A distance measurement sensor may be provided at a rear end of the drive module and configured to measure a distance from a front end of the coupled space module.

The distance measurement sensor may be configured as any one of an ultrasonic sensor, an infrared sensor, and a laser sensor.

According to the embodiment of the present disclosure, the exposure of the joint part may be prevented in the state in which the drive module and the space module of the PBV are separated, thereby improving the aesthetic appearance and preventing external contamination.

In addition, the compact structures of the spiral springs, the small-scale motor, and the gears are adopted, which may simplify the complexity of the system, reduce installation costs, and improve productivity.

In addition, fuel economy may be improved by reducing the weight of the vehicle.

### BRIEF DESCRIPTION OF THE DRAWINGS

FIG. 1 is a view illustrating an example of a PBV to which a structure for preventing exposure of a joint part of a vehicle body is applied, according to an embodiment of the present disclosure.

FIG. 2 is a view illustrating a rear side of a drive module to which the structure for preventing exposure of a joint part of a vehicle body is applied, according to an embodiment of the present disclosure.

FIG. 3 is a view illustrating a lateral side of the drive module of FIG. 2.

FIG. 4 is a front view illustrating the structure for preventing exposure of a joint part of a vehicle body according to an embodiment of the present disclosure.

FIG. 5 is a front view illustrating a state in which a blocking member of the structure for preventing exposure of a joint part of a vehicle body is folded, according to an embodiment of the present disclosure.

FIG. 6 is a front view illustrating a state in which the blocking member of the structure for preventing exposure of a joint part of a vehicle body is unfolded, according to an embodiment of the present disclosure.

FIG. 7 is a side view illustrating a state in which the blocking member of the structure for preventing exposure of a joint part of a vehicle body is unfolded according to an embodiment of the present disclosure.

FIG. 8 is a view illustrating a rear side of the drive module in which the structure for preventing exposure of a joint part of a vehicle body is installed, according to an embodiment of the present disclosure.

FIG. 9 is a view illustrating a coupling relationship between a driving gear and a guide track of the structure for preventing exposure of a joint part of a vehicle body according to an embodiment of the present disclosure.

FIG. 10 is a view illustrating a state in which a motor assembly is mounted according to an embodiment of the present disclosure.

FIG. 11 is a view illustrating a state in which a motor of the motor assembly is mounted on a motor fixing bracket, according to an embodiment of the present disclosure.

FIG. 12 is a view illustrating a state in which the motor of the motor assembly is fixed to the motor fixing bracket by bolting, according to an embodiment of the present disclosure.

### DETAILED DESCRIPTION

Hereinafter, embodiments of the present disclosure are described in detail with reference to the accompanying drawings so that those with ordinary skill in the art to which the present disclosure pertains may easily carry out the embodiments. The present disclosure may be implemented in various different ways and is not limited to the embodiments described herein.

In addition, the constituent elements having the same configurations in several embodiments are assigned with the same reference numerals and described only in the representative embodiment, and only the constituent elements, which are different from the constituent elements according to the representative embodiment, are described in other embodiments. When a component, device, element, or the like of the present disclosure is described as having a purpose or performing an operation, function, or the like, the component, device, or element should be considered herein as being “configured to” meet that purpose or to perform that operation or function.

It is noted that the drawings are schematic and are not illustrated based on actual scales. Relative dimensions and proportions of parts illustrated in the drawings are exaggerated or reduced in size for the purpose of clarity and convenience in the drawings, and any dimension is just illustrative but not restrictive. Further, the same reference numerals designate the same structures, elements or components illustrated in two or more drawings in order to exhibit similar characteristics. When one component is described as being positioned “above” or “on” another component, one component can be positioned “directly on” another component, and one component can also be positioned on another component with other components interposed therebetween.

The embodiments of the present disclosure specifically illustrate an example of the present disclosure. As a result, various modifications of the drawings are expected. Therefore, the embodiments are not limited to specific forms in regions illustrated in the drawings, and for example, include modifications of forms by the manufacture thereof.

Hereinafter, a structure of an apparatus for adjusting a vehicle body height and generating power according to an embodiment of the present disclosure is described in detail with reference to the accompanying drawings.

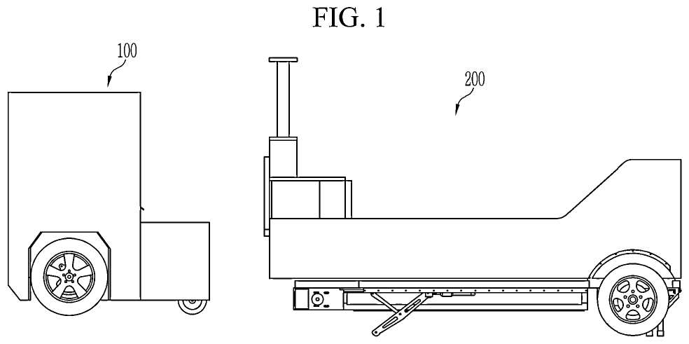

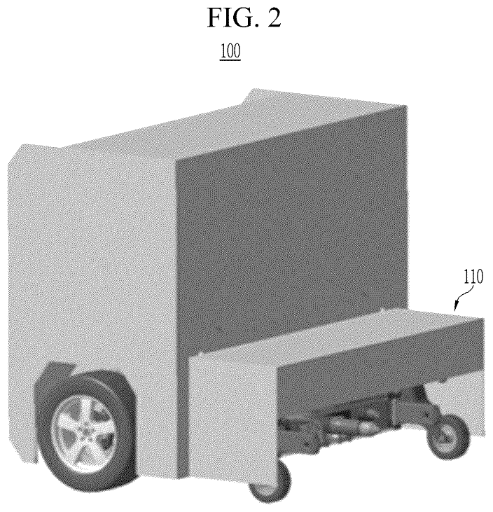

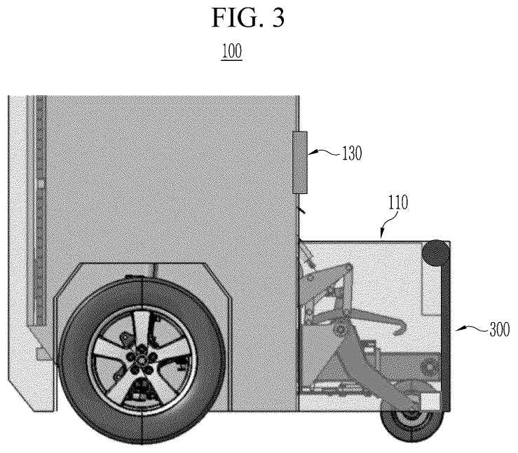

FIG. 1 is a view illustrating an example of a PBV to which a structure for preventing exposure of a joint part of a vehicle body is applied, according to an embodiment of the present disclosure. FIG. 2 is a view illustrating a rear side of a drive module to which the structure for preventing exposure of a joint part of a vehicle body is applied, according to an embodiment of the present disclosure. FIG. 3 is a view illustrating a lateral side of the drive module to which the structure for preventing exposure of a joint part of a vehicle body is applied, according to an embodiment of the present disclosure.

With reference to FIGS. 1-3, a structure 300 for preventing exposure of a joint part of a vehicle body according to an embodiment of the present disclosure may be applied to, for example, a purpose built vehicle (hereinafter referred to as a “PBV”).

The PBV may be used as a modular vehicle based on an electric vehicle that provides various customized services to a user during the time the PBV is moving from an origin to a destination.

A vehicle body of the PBV is a vehicle body suitable for small-quantity production of various types of vehicles having a small number of components. The vehicle body of the PBV may be manufactured to have various shapes and sizes.

The structure 300 for preventing exposure of a joint part of a vehicle body according to an embodiment of the present disclosure may be applied to a vehicle including a cab-type drive module 100 and a box-type space module 200 configured to be coupled to a rear end of the drive module 100. The drive module 100 and the space module 200 may be coupled by a coupling part 110 provided at the rear end of the drive module 100. The structure 300 for preventing exposure of a joint part of a vehicle body according to an embodiment of the present disclosure may be applied by being installed in the coupling part 110.

The present disclosure may be applied not only to the PBV implemented by coupling the drive module 100 and the space module 200, but also to various vehicles to which a vehicle body coupling structure of the vehicle is applied.

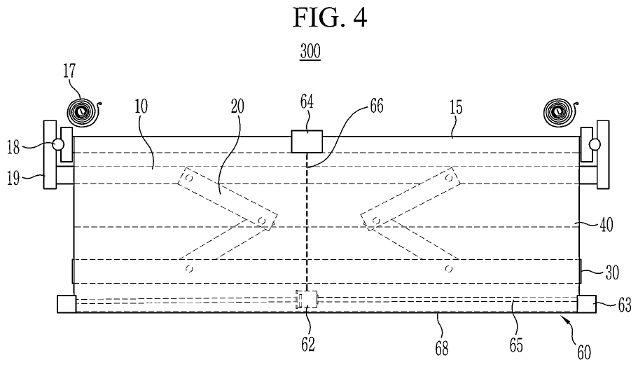

FIG. 4 is a view illustrating the structure for preventing exposure of a joint part of a vehicle body according to an embodiment of the present disclosure.

With reference to FIG. 4, the structure 300 for preventing exposure of a joint part of a vehicle body according to an embodiment of the present disclosure includes a first fixing member 10, a second fixing member 30, connection members 20, a blocking member 40, a rotary member 15, and a motor assembly 60.

The first fixing member 10 is disposed inside the coupling part 110 and extends in a horizontal direction perpendicular to a longitudinal direction of the drive module 100. Two opposite ends of the first fixing member 10 are fixed by mounting brackets 19 provided inside the coupling part 110.

The second fixing member 30 may be disposed to extend in the horizontal direction so as to be opposite to the first fixing member 10 (i.e., spaced apart in the vertical direction). A relative distance from the first fixing member 10 to the second fixing member 30 may change as the second fixing member 30 moves below the first fixing member 10 in the vertical direction.

The connection members 20 connect and support the first fixing member 10 and the second fixing member 30. When a relative distance between the first fixing member 10 and the second fixing member 30 is changed by the movement of the second fixing member 30, the connection member 20 also changes in shape.

The connection members 20 are provided as a pair of connection members 20, and each of the connection members 20 may be configured as a two-stage collapsible arm. The two-stage collapsible arms may operate to be folded or unfolded by being rotated by a rivet.

One end and the other end of the connection member 20 may be rotatably connected to the first fixing member 10 and the second fixing member 30, respectively. A center portion of the connection member 20 may be rotated by the rivet. With this structure, when the relative distance between the first fixing member 10 and the second fixing member 30 increases, the connection member 20 operates to be unfolded. When the relative distance decreases, the connection member 20 operates to be folded.

The blocking member 40 covers a relative distance or space defined by the first fixing member 10 and the second fixing member 30 to prevent the exposure of the components of the joint part of the vehicle body.

The blocking member 40 may be configured as an awning made of tarpaulin or soltop (SOL Tarpaulin). The blocking member 40 may be made of a waterproof material. Various materials, which is bendable while having an appropriate degree of hardness that may attenuate an impact from the outside, may be selected and used.

One portion (i.e., first or bottom portion) of the blocking member 40 may be connected to the second fixing member 30. The blocking member 40 may be extended or contracted by the movement of the second fixing member 30.

When the distance between the first fixing member 10 and the second fixing member 30 increases as the second fixing member 30 moves downward in the vertical direction, the blocking member 40 is unfolded downward and covers an opening of the coupling part 110 to prevent the components in the coupling part 110 from being exposed to the outside.

On the contrary, when the distance between the first fixing member 10 and the second fixing member 30 decreases as the second fixing member 30 moves upward in the vertical direction, the blocking member 40 moves upward and contracts, such that the components in the coupling part 110 are exposed to the outside.

In order to implement the above-mentioned operation, the other portion (i.e., second or top portion) of the blocking member 40 may be connected to the rotary member 15. The rotary member 15 may be disposed to extend in the horizontal direction in parallel with the first fixing member 10. When the second fixing member 30 and the blocking member 40 move, the rotary member 15 rotates to roll the blocking member 40 (i.e., allows the blocking member 40 to roll up).

Two opposite ends of the rotary member 15 may be rotatably coupled to the mounting brackets 19 by bearings 18. The rotary member 15 may have a cylindrical shape having a circular cross-section.

Spiral springs 17 may be provided inside the two opposite ends of the rotary member 15. The other portion of the blocking member 40 may be connected to the spiral springs 17.

The two opposite sides of the blocking member 40 may be connected to the spiral springs 17, such that tension may be maintained by the spiral springs 17 so that the blocking member 40 is kept taut without being creased in the state in which the blocking member 40 is unfolded downward. When an end of a spiral spring 17 is pulled by the blocking member 40, an elastic force is applied to the spiral spring 17 to return the spiral spring 17 to the original position. Therefore, in case that the blocking member 40 is fixed in a state of being unfolded downward, the spiral spring 17 coupled to an upper side of the blocking member 40 applies an elastic force, such that the blocking member 40 may be kept taut as a whole.

The motor assembly 60 provides driving power to move the second fixing member 30. The motor assembly 60 includes a motor 62, a connection rod 65 connected to two opposite sides of a rotary shaft of the motor 62 and extending in the horizontal direction, and driving gears 63 provided at two opposite ends of the connection rod 65.

The motor assembly 60 may be fixed to a motor fixing bracket 68. The motor fixing bracket 68 may be fixed to the second fixing member 30 and move together with the movement of the second fixing member 30. In other words, the motor assembly 60 moves the motor fixing bracket 68, and the motor fixing bracket 68 moves the second fixing member 30.

In response to a signal, the motor 62 may operate to move the second fixing member 30 upward or downward. To this end, an electric wire reel 64 is additionally provided at an inner central portion of the mounting brackets 19 and configured to receive electric power from the drive module 100. The electric wire reel 64 is connected to the motor 62 by a wire or wiring 66. When a distance signal between the drive module 100 and the space module 200 is inputted to the drive module 100, i.e., when a coupling or separation signal between the drive module 100 and the space module 200 is inputted, the motor 62 is operated by the electric power applied to the electric wire reel 64 and moves the second fixing member 30.

The electric wire reel 64 may be provided at the inner central portion of the mounting brackets 19. The wiring 66 may extend downward from the electric wire reel 64 in the vertical direction and be connected to the motor 62 positioned at a central portion of the motor fixing bracket 68.

A distance measurement sensor 130 may be provided at a rear end of the drive module 100 and configured to measure a distance from a front end of the space module 200 to the drive module 100. When a distance between the drive module 100 and the space module 200 measured by the distance measurement sensor 130 is equal to or smaller than a predetermined value, this situation is considered as a situation in which the drive module 100 and the space module 200 are coupled, such that electric power is applied to the motor 62 to move the second fixing member 30 and move the blocking member 40 upward so that the joint part is exposed.

On the contrary, when a distance between the drive module 100 and the space module 200 exceeds the predetermined value, this situation is considered as a situation in which the drive module 100 and the space module 200 are separated from each other, such that electric power is applied to the motor 62 to move the second fixing member 30 and move the blocking member 40 downward so that the joint part is covered.

The distance measurement sensor 130 may be configured as any one of an ultrasonic sensor, an infrared sensor, and a laser sensor. Other types of distance sensors, now known or later developed, may be used.

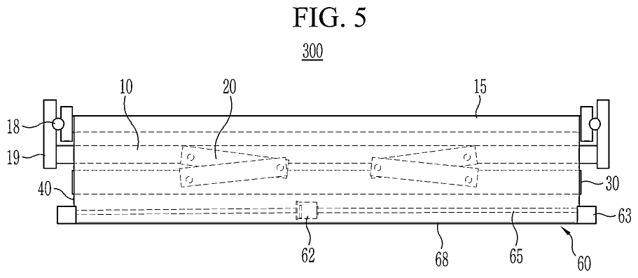

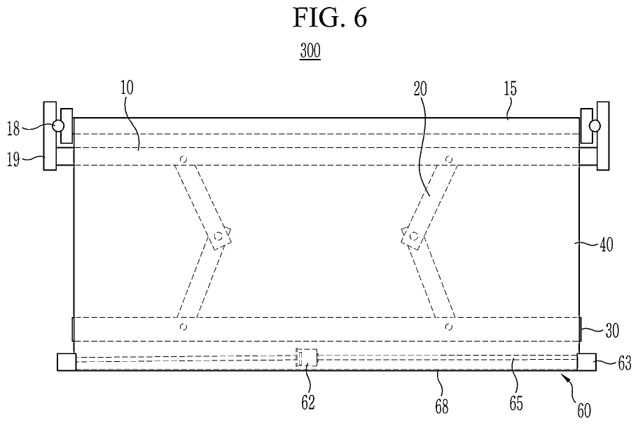

FIG. 5 is a front view illustrating a state in which a blocking member of the structure for preventing exposure of a joint part of a vehicle body is folded, according to an embodiment of the present disclosure. FIG. 6 is a front view illustrating a state in which the blocking member of the structure for preventing exposure of a joint part of a vehicle body is unfolded, according to an embodiment of the present disclosure.

As illustrated in FIG. 5, when the drive module 100 and the space module 200 are coupled, the motor 62 operates, the second fixing member 30 moves upward in the vertical direction, and the blocking member 40 moves upward and rolls along an outer surface of the rotary member 15.

In addition, as illustrated in FIG. 6, when the drive module 100 and the space module 200 are separated and only the drive module 100 travels or when the space module 200 is not used, the motor 62 may operate, the second fixing member 30 moves downward in the vertical direction, and the blocking member 40 is deployed downward, thereby preventing the exposure of the joint part.

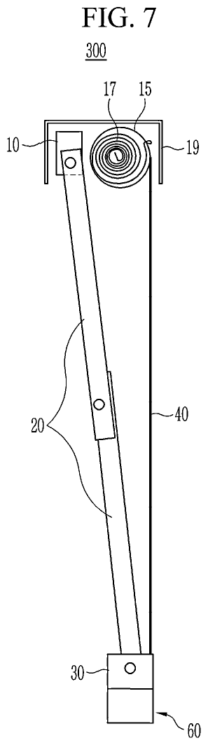

FIG. 7 is a side view illustrating a state in which the blocking member of the structure for preventing exposure of a joint part of a vehicle body is unfolded, according to an embodiment of the present disclosure.

As illustrated in FIG. 7, the first fixing member 10 and the rotary member 15 are disposed on the mounting bracket 19, the other portion (i.e., top portion) of the blocking member 40 is connected to the rotary member 15, and one portion (i.e., bottom portion) of the blocking member 40 is connected to the second fixing member 30. In the state in which the second fixing member 30 is moved downward, the connection member 20 is unfolded, and the blocking member 40 covers the relative distance or space between by the first fixing member 10 and the second fixing member 30, thereby preventing the exposure of the joint part. In this case, because tension is applied by the spiral springs 17 of the rotary member, the blocking member 40 may be kept taut without being creased.

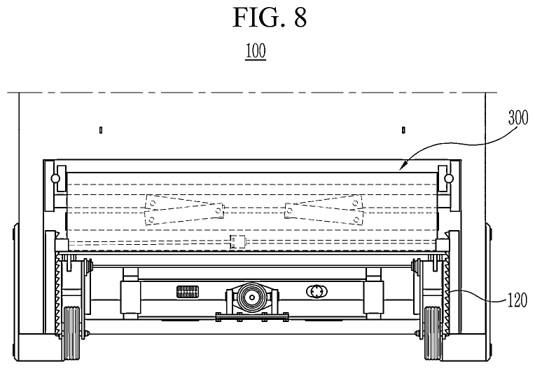

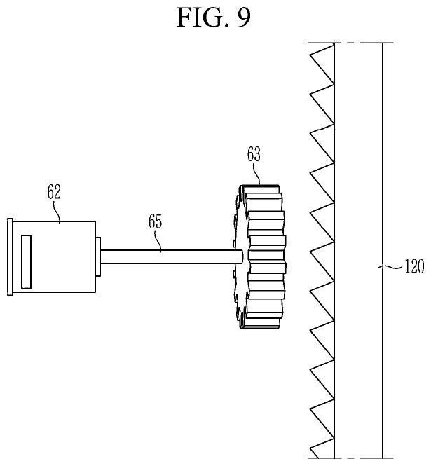

FIG. 8 is a view illustrating a rear side of the drive module in which the structure for preventing exposure of a joint part of a vehicle body is installed according to an embodiment of the present disclosure. FIG. 9 is a view illustrating a coupling relationship between a driving gear and a guide track of the structure for preventing exposure of a joint part of a vehicle body according to an embodiment of the present disclosure.

The movement of the second fixing member 30 performed by the motor 62 may be performed by coupling guide tracks 120, which extend in the vertical direction at two opposite ends inside the coupling part 110, to the driving gears 63 provided on the connection rod 65 connected to the two opposite sides of the rotary shaft of the motor 62.

In other words, when the motor 62 operates, the rotary shaft of the motor 62 and the connection rod 65 rotate, and the driving gears 63 rotate. The driving gear 63 may be configured as a pinion gear, and the guide track 120 may be configured as a rack gear. The engagement between the pinion gear and the rack gear may convert the rotational motion of the driving gear 63 into the rectilinear motions of the motor 62 and the second fixing member 30. Gear teeth of the guide track 120 illustrated in FIG. 8 may be directed toward the front side so as to correspond to gear teeth of the driving gear 63.

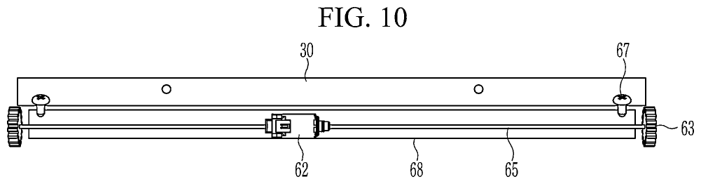

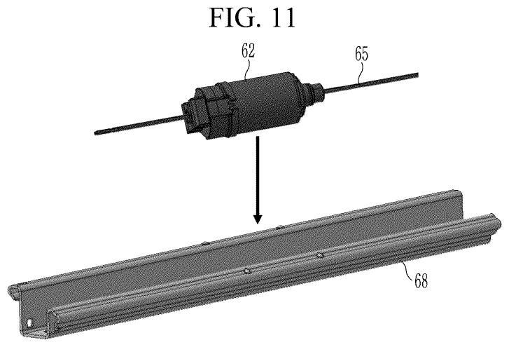

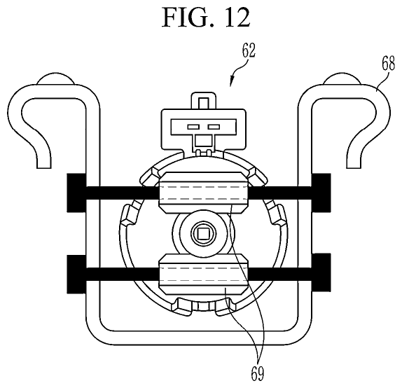

FIG. 10 is a view illustrating a state in which a motor assembly according to an embodiment of the present disclosure is mounted. FIG. 11 is a view illustrating a state in which a motor of the motor assembly is mounted on a motor fixing bracket according to an embodiment of the present disclosure. FIG. 12 is a view illustrating a state in which the motor of the motor assembly is fixed to the motor fixing bracket by bolting according to an embodiment of the present disclosure.

As illustrated in FIG. 10, the motor assembly 60 is fixed to the motor fixing bracket 68, and the motor fixing bracket 68 is connected to the second fixing member 30 by at least one bolt 67.

As illustrated in FIG. 11, the motor fixing bracket 68 may have a furrow shape extending in the horizontal direction of the drive module 100 so that the motor assembly 60 may be stably seated on the motor fixing bracket 68 without being withdrawn. The connection rod 65 connected to the rotary shaft of the motor 62 may be disposed to extend along the furrow shape of the motor fixing bracket 68.

As illustrated in FIG. 12, a fastening bracket 69 may be formed on an outer surface of the motor 62, and a bolt may be coupled to the fastening bracket 69 from the outside of the motor fixing bracket 68. The fastening bracket 69 may be provided as a plurality of fastening brackets 69, and the bolt may be provided as a plurality of bolts, such that the motor 62 is fixed to the motor fixing bracket 68 without rotating.

According to the embodiments of the present disclosure described above, the exposure of the joint part may be prevented in the state in which the drive module and the space module of the PBV are separated, thereby improving the aesthetic appearance and preventing external contamination.

In addition, the compact structures of the spiral springs, the small-scale motor, and the gears are adopted, which may simplify the complexity of the system, reduce the installation costs, and improve productivity.

In addition, fuel economy may be improved by reducing the weight of the vehicle.

While the embodiments of the present disclosure have been described, the present disclosure is not limited to the embodiments disclosed herein. The present disclosure covers all modifications that can be easily made from the embodiments of the present disclosure by those having ordinary skill in the art and considered as being equivalent to the present disclosure.

### DESCRIPTION OF SYMBOLS

100: Drive module
200: Space module
300: Structure for preventing exposure of joint part of vehicle body
10: First fixing member
15: Rotary member
17: Spiral spring
18: Bearing
19: Mounting bracket
20: Connection member
30: Second fixing member
40: Blocking member
60: Motor assembly
62: Motor
63: Driving gear
64: Electric wire reel
65: Connection rod
66: Wiring
68: Motor fixing bracket
69: Fastening bracket
110: Coupling part
120: Guide track
130: Distance measurement sensor

What is claimed is:

1. A structure for preventing exposure of a joint part of a vehicle body for a vehicle comprising a drive module and a space module configured to be coupled to a rear end of the drive module, the structure being configured to be applied to a coupling part, which is provided at the rear end of the drive module, the structure comprising:
a first fixing member disposed inside the coupling part and extending in a horizontal direction of the drive module;
a second fixing member extending in the horizontal direction and spaced apart from the first fixing member, the second fixing member being configured to move in a vertical direction so that a relative distance from the first fixing member is changeable;
a connection member configured to connect and support the first fixing member and the second fixing member and configured to be changed in shape by a movement of the second fixing member;
a blocking member having one portion connected to the second fixing member, the blocking member being configured to cover a relative distance or space, which is defined by a distance or space between the first fixing member and the second fixing member, by the movement of the second fixing member in order to prevent the joint part of the vehicle body from being exposed to the outside;
a rotary member extending in the horizontal direction in parallel with the first fixing member and connected to another portion of the blocking member, the rotary member being configured to rotate when the blocking member moves to roll the blocking member; and
a motor assembly configured to provide driving power to move the second fixing member.

2. The structure of claim 1, wherein two opposite ends of the first fixing member are fixed by a mounting bracket provided inside the coupling part.

3. The structure of claim 2, wherein two opposite ends of the rotary member are rotatably coupled to the mounting bracket by bearings.

4. The structure of claim 3, wherein spiral springs are provided inside the two opposite ends of the rotary member, and the other portion of the blocking member is connected to the spiral springs.

5. The structure of claim 1, wherein the connection member is a pair of connection members disposed in parallel between the first fixing member and the second fixing member.

6. The structure of claim 5, wherein the connection member is configured as two-stage collapsible arms connected by a rivet and configured to be unfolded or folded in accordance with the relative distance between the first fixing member and the second fixing member.

7. The structure of claim 4, wherein the other portion of the blocking member is connected to the spiral springs such that tension is maintained by the spiral springs, and the blocking member moves in accordance with a relative movement between the first fixing member and the second fixing member and rolls along an outer peripheral surface of the rotary member.

8. The structure of claim 7, wherein the blocking member is configured as an awning made of tarpaulin or soltop.

9. The structure of claim 1, wherein the motor assembly comprises:
a motor;
a connection rod connected to two opposite sides of a rotary shaft of the motor and extending in the horizontal direction; and
driving gears provided at two opposite ends of the connection rod.

10. The structure of claim 9, wherein the motor assembly is fixed to a motor fixing bracket fixed to the second fixing member and configured to move together with the movement of the second fixing member.

11. The structure of claim 10, wherein:
a fastening bracket is formed on an outer surface of the motor, and
the motor is coupled to the motor fixing bracket through the fastening bracket by bolting.

12. The structure of claim 9, wherein the driving gears are coupled to guide tracks formed at two opposite inner ends of the coupling part and extending in the vertical direction, and the driving gears move along the guide tracks.

13. The structure of claim 12, wherein the driving gear is configured as a pinion gear, and the guide track is configured as a rack gear.

14. The structure of claim 9, further comprising:
an electric wire reel provided at an inner central portion of the mounting bracket, connected to the motor by wiring, and configured to apply electric power.

15. The structure of claim 1, wherein a distance measurement sensor is provided at a rear end of the drive module and configured to measure a distance from a front end of the coupled space module.

16. The structure of claim 15, wherein the distance measurement sensor is any one of an ultrasonic sensor, an infrared sensor, and a laser sensor.
